(19) United States
(12) Patent Application Publication
(10) Pub. No.: US 2007/0264929 A1
(43) Pub. Date: Nov. 15, 2007

(54) SATELLITE COMMUNICATION SYSTEM ARCHITECTURE

(76) Inventor: Chao-Chun Chen, Torrance, CA (US)

Correspondence Address: Connolly Bove Lodge & Hutz LLP, Suite 800, 1990 M Street, N.W., Washington, DC, 20036, US

(21) Appl. No.: 11/627,569

(22) Filed: Jan. 26, 2007

Related U.S. Application Data
(63) Continuation-in-part of application No. 11/216,110, filed on Sep. 1, 2005.
(60) Provisional application No. 60/637,308, filed on Dec. 18, 2004.

(51) Int. Cl. H04K 3/00

(52) U.S. Cl. 455/1

(57) ABSTRACT

A satellite communication system architecture that supports both commercial and tactical applications may include polarization-based and/or frequency-based multiplexing and de-multiplexing and common routing. Such a satellite communication system may be implemented in such a way as to minimize intentional interference.

### CROSS-REFERENCE TO RELATED APPLICATION

This application is a continuation-in-part of U.S. patent application Ser. No. 11/216,110, filed on Sep. 1, 2005, which claims the priority of U.S. Provisional Patent Application No. 60/637,308, filed on Dec. 18, 2004, both of which are incorporated herein by reference.

### BACKGROUND OF THE INVENTION

1. Field of the Invention

This invention generally relates to communication systems. Specific embodiments of the invention relate to satellite-based communication systems, which may use one type of waveform for transmitting tactical/military user signals and a second type of waveform for transmitting commercial/non-military user signals. Tactical user signals and commercial signals may be digitally processed separately and passed to a common router to enable connection of tactical users to commercial users, or vice versa, without relaying to the ground for processing and routing.

2. Related Art

Satellite-based communications has become more and more prevalent throughout the world. Satellite-based communication systems may be particularly useful as parts of long-distance communication systems, as well as in providing communication coverage to remote areas of the world, for example. Satellite communication systems are in use today for both commercial and military communications.

FIG. 1 illustrates one type of communications satellite network architecture. The key elements employed in this satellite network include: receive antenna 101, low-noise amplifier (LNA) 102, down-converter (D/C) 103, frequency-based analog channelizer or input-multiplexer (I-MUX) 104, router/channel amplifier 105, up-converter (U/C) 106 (which may include further amplification 107), output multiplexer (O-MUX) 108, and transmit antenna 109. This is an analog transponder and is commonly called a “bent-pipe” transponder. Satellite earth stations, e.g., 110, 111, communicate by transmitting signals to receive antenna 101 (i.e., via an uplink (U/L) channel) and receiving signals from transmit antenna 109 (i.e., via a downlink (D/L) channel). Most commercial communications satellites built before 1995 use this type of simple network architecture.

A system like that shown in FIG. 1 typically employs frequency-division multiple-access (FDMA) techniques on the U/L channel. The signals are processed by the satellite and relayed back to terminals on the D/L channel, also typically using FDMA techniques.

The uplink signals received by the satellite antenna 101 are magnified and down converted to intermediate frequencies (IF) via LNA 102 and D/C 103. The IF signals are channelized in an input-multiplexer 104 and amplified and routed to their designated antenna beams by channel amplifiers and analog switch 105. On the D/L, the outputs from the switch 105 will be up-converted to the D/L frequencies by a U/C 106. The signal power may then be magnified by a D/L amplifier 107, which may comprise a solid-state power amplifier (SSPA) or a traveling wave tube amplifier (TWTA). The O-MUX 108 placed at the input to transmit antenna may be used to combine multiple frequency channels for transmission using transmit antenna 109.

This analog repeater (or bent-pipe transponder) architecture is vulnerable to uplink interference. It can be easily disrupted by intentional interference, as well as by unintentional interference because there is no onboard signal processing capability to remove or suppress the interference. If the uplink interference signal is stronger than the desired signal, the interference signal may dominate the satellite amplification power and result in an extremely corrupted output signal. Nevertheless, most C and Ku band communication satellites, such as the Singapore and Taiwan Satellite (ST-1) currently in operation, employ this type of bent-pipe transponder because of its simplicity and low cost.

FIG. 2 shows a second conventional satellite communication system architecture, which builds on the bent-pipe architecture shown in FIG. 1. The architecture shown in FIG. 2 is often referred to as a double-hop bent-pipe architecture. A first satellite link, often referred to as the “return” link receives signals from transmitting earth stations 201 and transmits them to a first bent-pipe satellite system (205-211), which de-multiplexes, switches/amplifies, multiplexes, and re-transmits the signals down to an earth station 203 coupled to a network operations center (NOC) 204. Earth station 203 and NOC 204 serve as a gateway. Such a gateway may typically serve multiple satellites; note that an overall system may contain multiple gateways. The gateway routes signals received via a return link to an appropriate forward link for transmission to a receiving earth station 202. The forward link comprises a satellite (212-218) similar to that of the return link. The U/L and D/L channels of each of the forward link and return link may use different frequency bands, to help avoid mutual interference.

While the double-hop bent-pipe architecture may result in increased network coverage, it is still subject to the same type of interference problems that are encountered in the single-hop bent-pipe architecture. Additionally, the use of a second hop and intermediate signal processing introduces further delays, which may negatively impact, for example, voice communications.

FIG. 3 shows a conventional commercial digital communications satellite system architecture. Ground stations 301 transmit uplink signals to a satellite antenna 303, which feeds the signals through an RF module 304 that may include one or more LNAs and one or more D/Cs (each of which may comprise a mixer and a local oscillator (LO)). The resulting signals, which may then be de-multiplexed in frequency or channelized and switched (which may involve a beam and/or channel switch following RF module 304 (not shown)), are then fed to an U/L digital processing module 305, which may have one or more demodulators and/or decoders. The resulting signals are then passed to a router 306. Router 306 may perform functions including packet recovery, packet header reading, and/or destination sorting and may comprise one or more packet switches or asynchronous transfer mode-like (ATM-like) cell switches. Router 306 may further include one or more frame buffers.

Alternatively, in some embodiments, the uplink signals are not decoded into address-based data bits. In such cases, instead of packet/cell-based switching, router 306 may use one or more time-based circuit switches to perform switching of signals.

The signals from router 306 may be passed along for D/L processing. This may include D/L digital processing 307, which may include one or more data frame buffers or encoders and one or more modulators. The resulting signals are then passed to D/L RF module 308, which may include one or more U/Cs and SSPAs and/or TWTAs. The resulting signals may then be transmitted via one or more D/L antennas 309 to ground stations 302.

In general, the signal flow is as follows. U/L signals are amplified and down-converted 304 to an intermediate frequency (IF). The IF signals may be further down-converted, channelized, and demodulated (the latter may be performed in block 305) to baseband for decoding (also in block 305). The decoded information may be forwarded to router 306 for switching, as discussed above. The switch outputs may be buffered for multiplexing and reformatting. The results may be forwarded for D/L processing, to be encoded and remodulated 307. The resulting signals are then up-converted and power-amplified 308, and the resulting signals transmitted.

In the system of FIG. 3, the U/L may use FDMA, time-division multiple-access (TDMA), or a combination of these techniques, and these may further incorporate a demand-assignment multiple-access (DAMA) protocol. Other multiple-access techniques may also be used. Also, many different types of waveforms may be used. The D/L commonly uses a single time-division multiplexed (TDM) carrier per D/L channel, but other schemes may be used.

The system of FIG. 3 may encounter interference signals, but the on-board signal processing may serve to reduce the effects of such interference via the process of demodulation/decoding and recoding/remodulating prior to retransmission.

FIG. 4, in contrast, shows an example of an implementation of a military satellite communication system. Military systems are typically designed to anticipate the presence of hostile interference jamming) signals. Therefore, such systems may employ spread-spectrum (SS) techniques and/or sophisticated multiplexing techniques to protect the signals from jamming, as well as to prevent exploitation of such signals by enemy forces. Therefore, while the system of FIG. 4 bears some resemblance to the commercial system shown in FIG. 3, the system as shown in FIG. 4 adds frequency hopping (FH) to the system and omits packet/cell-type switching from the router.

In operation, a transmitting station 401 transmits an FH-modulated signal to the satellite, via U/L antenna 403. The received signal is then passed to an U/L RF module 405, which may include amplification and down-conversion, as well as de-spreading. For FH de-spreading, a pseudo-noise (PN) code generator and frequency synthesizer 404 are typically used to generate the necessary signals for U/L RF module 405 to perform de-spreading (which may, in some cases, be combined with down-conversion). Module 405 typically includes filtering to remove spurious signals. The resulting signals, now at IF, may be further down-converted and de-multiplexed, and are passed to U/L processor 406, which may include demodulation, de-permutating, de-interleaving, and/or decoding. The resulting digital signals are then passed to router 407 for multiplexing and formatting in frame buffers and are queued for D/L processing. D/L processing 408 may include coding, interleaving, permutation, and/or modulation. The resulting signals are passed to D/L RF module 410, which may include up-conversion, spreading (again, using FH) and amplification. Again, a module 409 may include PN code generation and frequency synthesis to generate the necessary signals for module 410 to generate the FH waveform, and module 410 may typically include bandpass filtering (BPF). The resulting signals are transmitted to receiving stations 402 via D/L antenna(s) 411.

A system like the one shown in FIG. 4 has the advantage that the effects of strong interference signals may be mitigated by the sophisticated signal processing techniques used (including SS signaling and/or robust encoding/interleaving/permutation). However, this resistance to interference comes at the expense of complexity and cost.

It is further noted that military systems may employ other types of SS signaling, e.g., direct-sequence spread-spectrum (DSSS) signaling, instead of FH. In such cases, the de-spreading process is performed in U/L processing module 406, and re-spreading may be done in D/L processing module 408, where each would typically be furnished with PN generation capability.

Thus, it is seen that commercial and military satellite communication systems may have some similarities in their satellite on-board processing (OBP) capabilities and techniques, but there are typically also significant differences. Such differences must be addressed if both military and commercial users are to be able to share satellite resources and to thus share the cost of providing such satellite resources.

Additionally, problems arise due to limited availability of resources. Limited bandwidth allocations are available, for example, to smaller countries. Furthermore, orbital locations for satellites are becoming less and less available as the standard orbits become more and more congested with satellites; this may lead to mutual interference between communication signals to and from satellites located close to each other. Therefore, systems in which resources are shared are desirable, in order to optimize use of available resources, and it is also desirable to design such systems to minimize mutual interference between signals.

### SUMMARY OF THE INVENTION

Embodiments of the present invention may be used to optimize usage of available satellite resources by providing a shared military/non-military satellite communication architecture. Such an architecture may be provided by including in a satellite payload components needed by each portion of the system and components that may be shared among portions of the system. The architecture may also include the use of satellite placement and/or particular deployment strategies in order to reduce a threat of hostile electronic interference and/or physical attacks. Such strategies may be augmented with additional strategies at one or more terrestrial terminals (where “terrestrial” may denote land-, sea-, or air-based terminals, but not space-based terminals).

### BRIEF DESCRIPTION OF THE DRAWINGS

The foregoing and other features of various embodiments of the invention will be apparent from the following, more particular description of such embodiments of the invention, as illustrated in the accompanying drawings, in which:

FIGS. 1-4 depict typical satellite communication system architectures for commercial and/or military use;

FIG. 5 depicts a block diagram of a satellite communication system architecture according to some embodiments of the invention;

FIG. 6 depicts a block diagram of a satellite communication system architecture according to some further embodiments of the invention;

FIG. 7 depicts yet a further block diagram of a satellite communication system architecture according to some additional embodiments of the invention; and

FIGS. 8a and 8b illustrate various interference effects that may be used to illustrate embodiments of the invention.

### DETAILED DESCRIPTION OF EMBODIMENTS OF THE PRESENT INVENTION

Exemplary embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

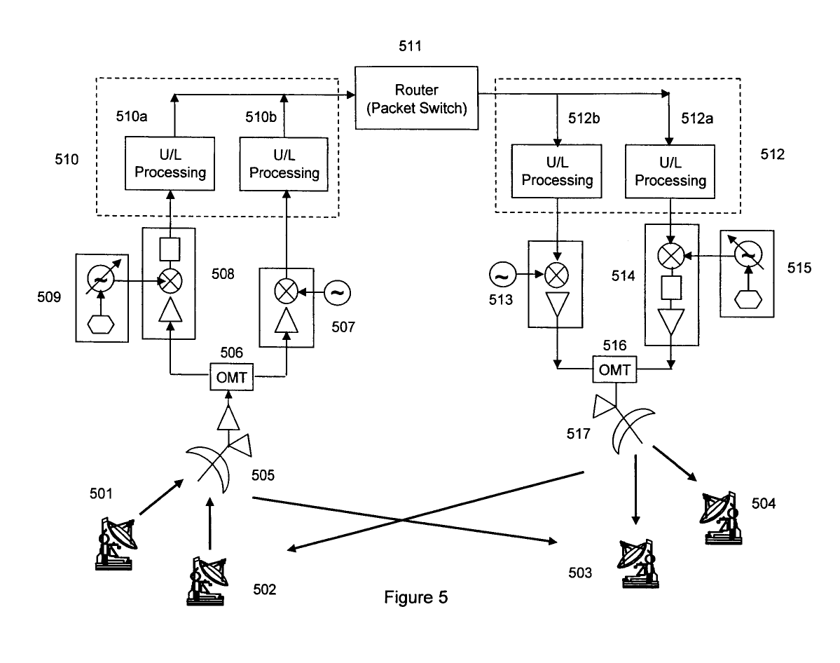

FIG. 5 depicts an exemplary embodiment of the present invention. In FIG. 5, both military users 501, 504 and non-military users 502, 503 may share common resources of a single satellite processing system 505-517. In particular, the system of FIG. 5 may have military users, e.g., 501, transmitting using SS signaling, which may be FH signaling, as discussed above, and the uplink SS signals may be received at the satellite by an antenna 505, which may, for example, include a beam-forming network (BFN) and/or be gimbaled. A BFN may be used to provide multiple uplink channels (and to create associated channel separation among different uplink signals (and similarly on the downlink)), as well as some degree of out-of-band interference rejection. The antenna itself may be a reflector, an array of radiating elements, or some other suitable type of antenna.

In embodiments of the invention, antenna 505 may also include separation of uplink signals according to polarization. That is, military users may use one signal polarization, while non-military users may use a different polarization, and these polarizations may be designed to be mutually orthogonal, to maximize frequency reuse. In such a system, an orthogonal mode transducer (OMT) 506 or other module for separating polarized signals may be used to separate the military and non-military received signals, according to polarization.

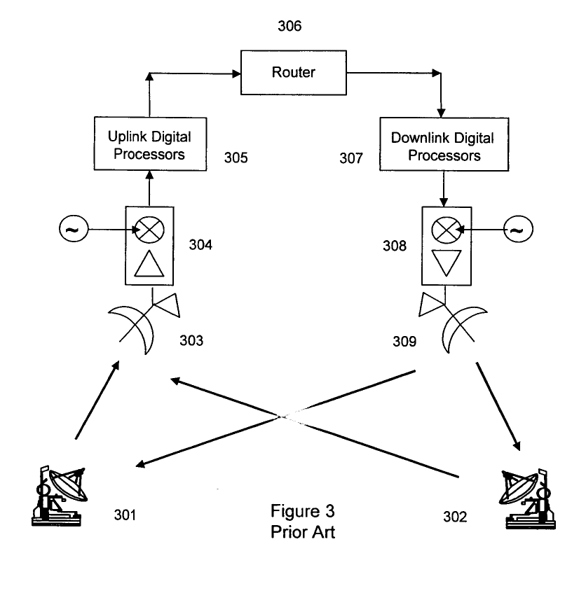

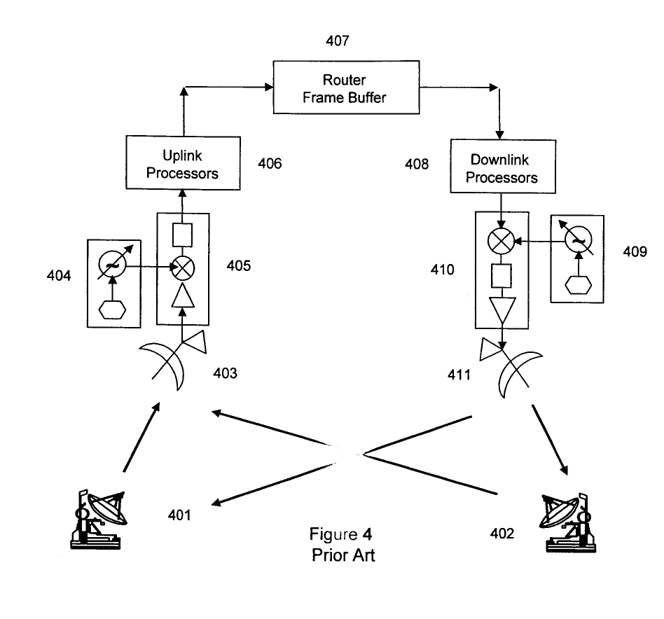

The system shown in FIG. 5 includes many of the same components found in the systems of FIGS. 3 and 4, with some modifications. In particular, military signals may be fed to an U/L RF module 508, which may be similar to module 405 in FIG. 4, and which may be provided with a de-spreading signal generator 509, which may be similar to module 404. Non-military signals may be provided to U/L RF module 507, which may be similar to module 304 of FIG. 3. The resulting IF signals from modules 507 and 508 are then provided to an U/L processing module 510. The military signals may be provided to a module 510a that may be similar to module 406 of FIG. 4, while the non-military signals may be provided to a module 510b that may be similar to module 305 of FIG. 3. The resulting baseband signals are then provided to a router 511. Router 511 may be of the packet/cell switch type, as discussed above in connection with FIG. 3. As discussed above, router 511 may employ any known, or as yet to be developed, switching technology, including time-division, frequency-division, code-division, optical (e.g., wavelength-division), and combinations thereof. Use of a single router 511 for both military and non-military signals may serve to reduce the cost of the satellite payload; in the embodiment of FIG. 5, the military users may use signaling that permits routing similar to that used by non-military users (as in FIG. 3).

Router 511 may be used to route the various baseband signals onto appropriate D/L signals. The baseband D/L signals are then provided to D/L processing module 512, which may comprise separate modules 512a, 512b for processing of military and non-military signals. The processing module 512a for military applications may be similar to module 408 of FIG. 4, while the processing module 512b for non-military applications may be similar to module 307 of FIG. 3.

IF military signals from processing module 512 may next be sent to RF module 514 for up-conversion and spreading (this may be similar to module 410 of FIG. 4), which may receive spreading signals from module 515 (which may be similar to module 409 of FIG. 4). IF non-military signals may be routed to RF module 513, which may be similar to module 308 of FIG. 3. The resulting RF signals are then sent to a downlink OMT 516 (or other module for providing signals of different polarizations) for multiplexing (that is, in the polarization domain). Again, non-military signals use one polarization, and military users use a second polarization, and these polarizations may be mutually orthogonal, to reduce mutual interference between military and non-military signals. The resulting polarized signals are then transmitted via D/L antenna 517.

By employing frequency reuse techniques, the architecture of FIG. 5 may result in increased bandwidth efficiency while also camouflaging the military channels under the non-military channels.

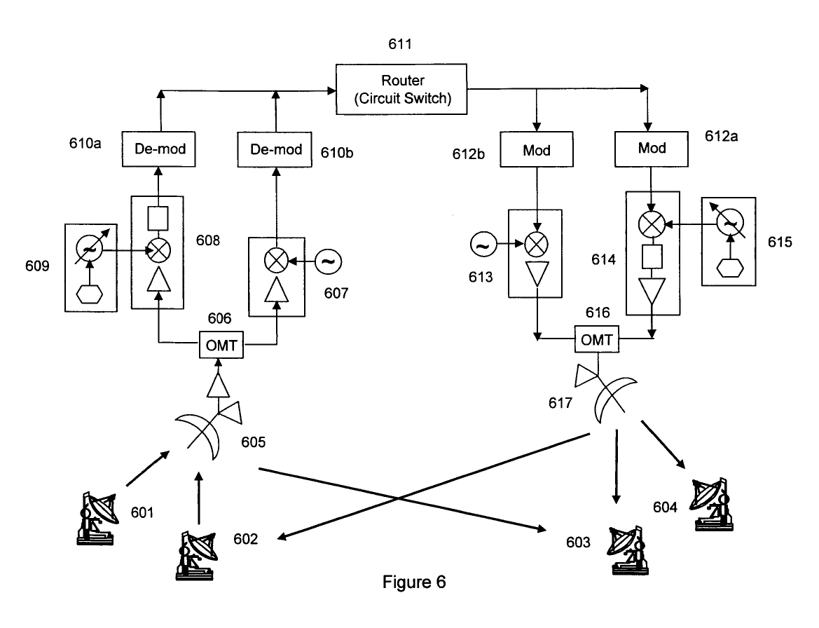

FIG. 6 shows a satellite communication system architecture according to a further embodiment of the invention. The embodiment of FIG. 6 is similar to the embodiment shown in FIG. 5, except for some variation in OBP. In particular, components 601-608 and 613-617 may be similar to components 501-508 and 513-517 of FIG. 5. However, in this embodiment, router 611 comprises a time-based circuit switch, which may be similar to that of FIG. 4, rather than a packet/cell-based switch (as, e.g., in FIGS. 3 and 5). Correspondingly, the uplink processing of IF signals may not completely process the signals down to the address-based data bit level. For example, this processing may include demodulators 610a and 610b on the U/L side. Corresponding modulators 612a and 612b may be provided on the D/L side.

The embodiment of FIG. 6 permits the use of processing similar to that of the military system architecture of FIG. 4, in that it provides for circuit-switched routing, rather than packet/cell-switched routing. Military users may prefer such a scheme, for example, to ensure channel availability.

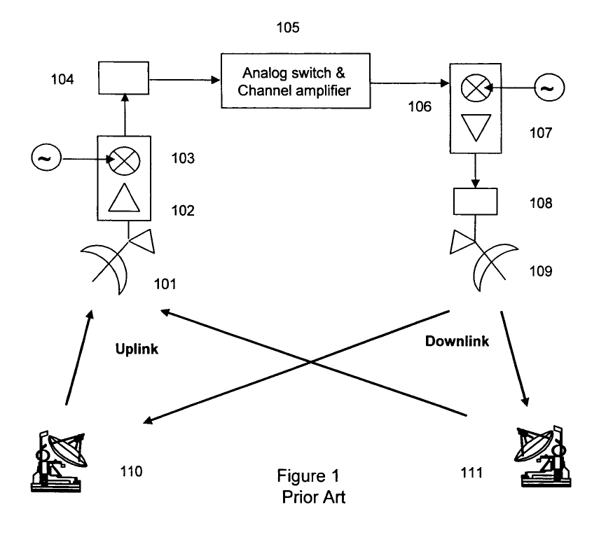

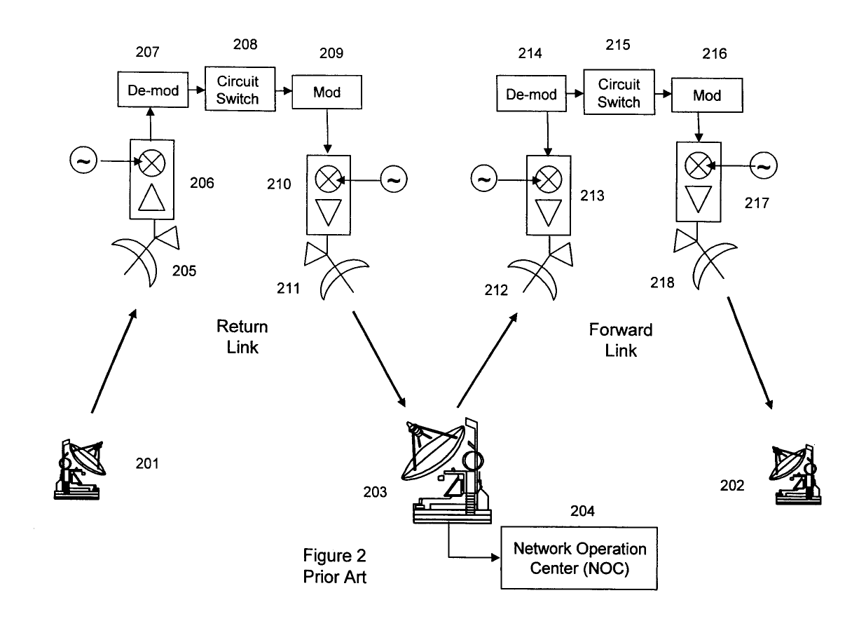

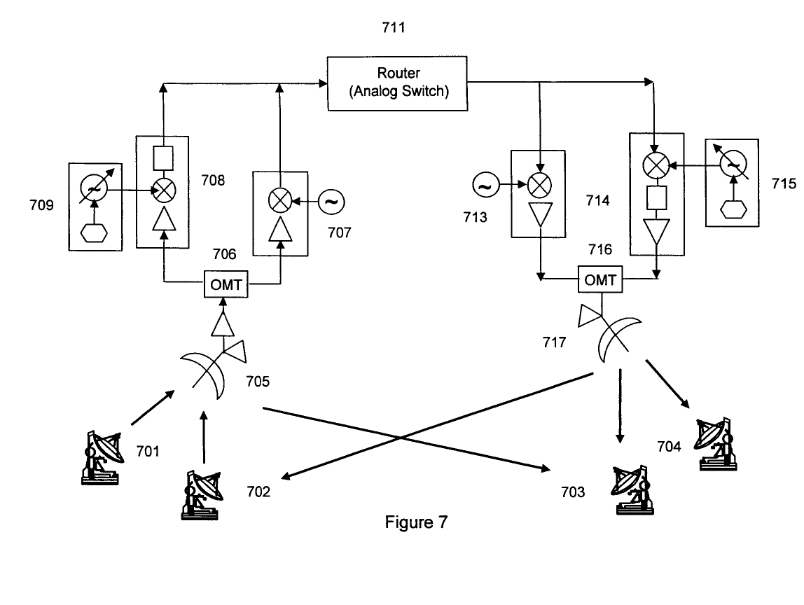

In some scenarios, it may be desirable to simplify the embodiment of FIG. 6, for example, where budgetary considerations may dictate a simpler satellite architecture. FIG. 7 shows an embodiment of the invention comprising a satellite payload that may be used to meet such constraints. FIG. 7 is identical to FIG. 6, except that router 611, which implements (digital-based) circuit switching, may be replaced by router 711, which provides analog switching. Such a router thus may operation closer to that of a bent-pipe-type operation (see, e.g., above discussion in connection with FIG. 1). When this change is made, demodulators 610a, 610b and modulators 612a, 612b may no longer be necessary, thus simplifying the satellite payload, as shown in FIG. 7. Thus, the satellite of FIG. 7 may be cheaper and/or lighter than the satellite of FIG. 6, which may make it more suitable, e.g., for smaller, less-affluent nations.

In some embodiments of the invention, the uplink and downlink signals may comprise C-band and Ku-band signals (i.e., in the SHF band). An advantage to using signals in these bands is that the necessary equipment to transmit, receive, and process these signals is readily available. Another advantage is increased tolerance to various atmospheric conditions (e.g., rain), as compared to signals in higher bands (e.g., Ka-band and other EHF signals). A third advantage is that the frequency reuse techniques of the various embodiments of the present invention may work most optimally for C- and Ku-band signals (and, again, signals generally in the SHF band). However, the invention need not necessarily be limited to signals in these specific bands.

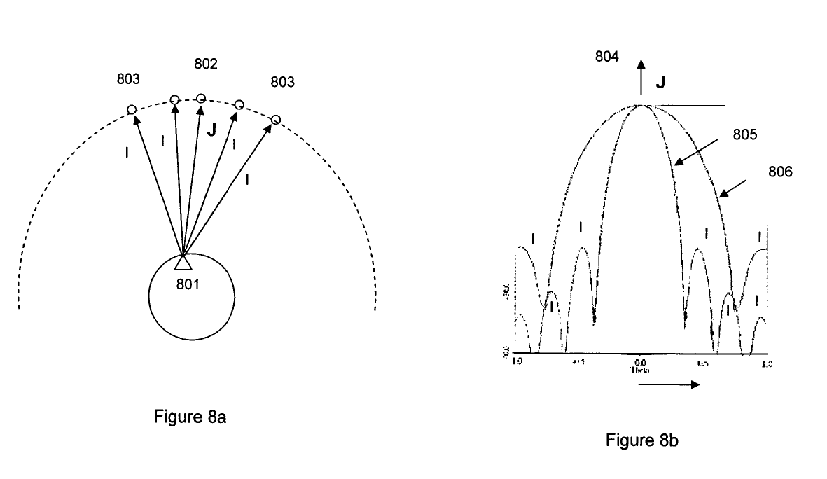

FIGS. 8a and 8b show various cases of interference with satellite communications and may be used to discuss how embodiments of the invention may mitigate such interference. As shown in FIG. 8a, a jamming ground station 801, which may represent an intentional or unintentional interferer, may direct a signal toward a target satellite 802. For the purpose of the present discussion, it will be assumed that ground station 801 is an intentional interferer (jammer). The intentional interference signal is marked with the letter J. However, as shown in FIG. 8b, a typical ground station antenna will have both a main lobe J 804 and sidelobes I. In general, the sizes (or, more particularly, the magnitudes, as well as the radiation angles) of the main lobe and sidelobes may depend on the antenna size and shape (for example, the curve 805 may represent a larger antenna than the curve 806). The sidelobes I may result in unintentional interference signals I in FIG. 8a being directed to nearby satellites 803 (here, all satellites 802, 803 are shown in geostationary orbit, represented by the dashed line in FIG. 8a; however, the concepts shown here may be generalized to satellites in other types of orbits). It is noted that the military channels may be able to mitigate the effects of the jamming signals, due to the use of SS signaling; however, the non-military channels are likely to be disrupted.

However, placement of a satellite relative to its adjacent satellite positions may greatly affect the vulnerability of the satellite to interference from ground-based jammers. For example, ground-based jammer 801 may be limited in effective isotropic radiated power (EIRP), insofar as if its power of its main lobe is increased, its sidelobes will increase in size, proportionally, resulting in further unintentional jamming (which may unintentionally even be directed against the jammer's own satellites and/or satellites of uninvolved parties). As a result, it may be advantageous to locate one's satellite, for example, a satellite shared by tactical (military) and non-tactical (commercial) channels, in relatively close proximity or adjacent to one's enemy's satellites (or those of uninvolved parties), in order to discourage that enemy from increasing its jamming power against one's satellite.

The above-mentioned strategy is, however, not the only strategy that may be employed to defeat jamming. Another strategy that may be used, which may rely on similar principles, would be, instead of placing one's own satellite in orbit, to “piggyback” one's satellite payload on a satellite of an uninvolved party. As a result, any attempt to jam one's communications would also result in also jamming other communications on the same satellite and/or nearby satellites occurring in the same band (and/or possibly in other bands, e.g., as may be caused by the jamming signal's sidelobes). An additional benefit that may be obtained by piggybacking one's payload on an uninvolved party's satellite is to avoid a hostile party's physical attack (e.g., using space-based missiles or high kinetic energy lasers), which would not only disable one's communications but would also disable all communications using the satellite (and may thereby cause previously uninvolved parties to intervene).

Another sheltering strategy that may be used may be, instead of using one's own satellite or piggybacking one's payload on an uninvolved party's satellite, to lease satellite resources from an uninvolved party (e.g., an uninvolved nation or a commercial enterprise). This may, however, affect the availability of uplink and/or downlink processing components.

Yet another strategy that may be used would be to increase the EIRP of a transmitting terminal, e.g., using a high-power amplifier, to overcome the jammer power (e.g., on the uplink channel). Furthermore, one may also (or instead) use sophisticated antenna technologies (e.g., antenna arrays with beamforming networks, et al.) at the uplink receiving antenna of the satellite, e.g., to null out jamming signals or to increase the signal to jamming energy ratio at the uplink receiving antenna. Note that this latter technique may, however, require additional on-board processing.

In general, one may use one or more of the satellite implementation strategies (e.g., placement of the satellite, piggybacking, and/or leasing a transponder) as an initial means by which to avoid jamming. One may also use antenna technologies on the satellite. Finally, one may equip a terrestrial transmitter with additional amplification capabilities so that, if the jammer is somehow able to overwhelm the pre-existing measures, the additional amplification may be used to overcome the jamming. Additionally, one may employ these various means of mitigating the effects of jamming in various combinations, as desired.

As discussed above, embodiments of the invention may utilize separation of military and non-military signals by polarization. However, it is also possible to implement other embodiments of the invention in which military and non-military signals are transmitted in different frequency bands, with or without different polarizations. In such cases, in the respective embodiments of FIGS. 5, 6, and 7, the OMTs 506, 516, 606, 616, and 706, 716 may be replaced with appropriate frequency de-multiplexing and multiplexing modules.

The invention is described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. A method of protecting satellite communications of a first party from hostile jamming associated with a second party, the method comprising:
implementing, by said first party at least one satellite payload sheltering strategy selected from the group consisting of:
placing a satellite of the first party, said satellite containing said satellite payload, in a location within an orbit around the earth, wherein said location is within a range in which at least one other satellite located in said orbit, adjacent to said satellite, and belonging to either the second party or to an uninvolved third party would be unintentionally jammed if said satellite were intentionally jammed;
piggybacking said satellite payload of the first party on a satellite belonging to a third party, said third party being non-hostile with respect to said second party; and
leasing a satellite transponder from a third party, said third party being non-hostile with respect to said second party, and implementing said satellite payload using said satellite transponder; and
transmitting said satellite communications of the first party via the resulting sheltered satellite payload.

2. The method according to claim 1, further comprising:
increasing an effective isotropic radiated power (EIRP) of a terminal transmitting said satellite communications of the first party.

3. The method according to claim 1, further comprising:
utilizing at least one antenna technology to mitigate said hostile jamming.

4. The method according to claim 3, wherein said utilizing comprises:
using an antenna beamforming array to reduce an amount of power received from said hostile jamming.

5. The method according to claim 1, further comprising:
receiving uplink signals comprising tactical signals of said first party using a first polarization and non-tactical signals transmitted using a second polarization;
separating said tactical and non-tactical signals;
routing the tactical and non-tactical signals using a common satellite-based router into downlink tactical signals and downlink non-tactical signals; and
combining the downlink tactical signals and downlink non-tactical signals into downlink tactical and non-tactical signals using third and fourth polarizations, respectively.

6. The method according to claim 1, further comprising:
receiving uplink signals comprising tactical signals of said first party using a first frequency band and non-tactical signals transmitted using a second frequency band;
separating said tactical and non-tactical signals;
routing the tactical and non-tactical signals using a common satellite-based router into downlink tactical signals and downlink non-tactical signals; and
combining the downlink tactical signals and downlink non-tactical signals into downlink tactical and non-tactical signals using third and fourth frequency bands, respectively.

7. A satellite communications apparatus, comprising:
a satellite payload for communications by a first party that are to be sheltered from hostile jamming by a second party using a sheltering strategy selected from the group consisting of:
placing a satellite, said satellite containing said satellite payload, in a location within an orbit around the earth, wherein said location is within a range in which at least one other satellite located in said orbit, adjacent to said satellite, and belonging to either the second party or to an uninvolved third party would be unintentionally jammed if said satellite were intentionally jammed;
piggybacking said satellite payload of the first party on a satellite belonging to a third party, said third party being non-hostile with respect to said second party; and
leasing a satellite transponder from a third party, said third party being non-hostile with respect to said second party, and implementing said satellite payload using said satellite transponder.

8. The apparatus according to claim 7, further comprising:
at least one antenna array to be deployed on an uplink channel to process uplink signals to reduce received hostile jamming power.

9. The apparatus according to claim 8, further comprising:
beamforming apparatus associated with said antenna array.

10. The apparatus according to claim 7, wherein said satellite payload comprises:
at least one module selected from the group consisting of: (a) an uplink polarization separation module to separate received signals of different polarizations into separate signals, and (b) an uplink frequency de-multiplexing module to separate frequency multiplexed signals into separate signals;
a routing module coupled to said uplink polarization separation module to route said separate signals to signals for downlink processing; and
at least one module selected from the group consisting of: (a) a downlink polarization module to combine said signals for downlink processing into transmitted signals using a different polarization for each of said signals for downlink processing, and (b) a downlink frequency multiplexing module to combine said signals for downlink processing into transmitted signals using a different frequency band for each of said signals for downlink processing.

11. A satellite communication system, comprising:
the apparatus according to claim 7; and
at least one terrestrial terminal, the at least one terrestrial terminal being adapted to transmit with an increased amount of power to mitigate effects of hostile jamming.
